(19) United States
(12) Patent Application Publication
(10) Pub. No.: US 2021/0352527 A1
(43) Pub. Date: Nov. 11, 2021

(54) SCALABLE SIZING OF TRANSPORT BLOCKS FOR UPLINK TRANSMISSIONS

(71) Applicant: QUALCOMM Incorporated, San Diego, CA (US)

(72) Inventors: Gokul SRIDHARAN, Sunnyvale, CA (US); Gabi SARKIS, San Diego, CA (US); Hung Dinh LY, San Diego, CA (US); Krishna Kiran MUKKAVILLI, San Diego, CA (US); Wanshi CHEN, San Diego, CA (US); Peter GAAL, San Diego, CA (US); Xipeng ZHU, San Diego, CA (US); Min WANG, San Diego, CA (US)

(21) Appl. No.: 17/316,605

(22) Filed: May 10, 2021

Related U.S. Application Data
(60) Provisional application No. 63/023,227, filed on May 11, 2020.

(51) Int. Cl. H04W 28/06; H04L 1/18; H04W 72/04; H04W 72/12

(52) U.S. Cl. CPC H04W 28/06; H04W 72/1268; H04W 72/0446; H04L 1/1819

(57) ABSTRACT

A UE may be configured to determine a size of the TB for transmission to a base station based on signaling received from the base station for configuration of at least one of a scale factor or a slot aggregation factor associated with size of the TB. The UE may be further configured to transmit, to the base station, information on the TB in at least one slot, the TB being of the determined size. The base station may be configured to transmit, to the UE, the signaling for configuration of at least one of a scale factor or a slot aggregation factor associated with a size of the TB to be used by the UE for transmission. The base station may be further configured to receive, from the UE, information on at least one TB having a size that is based on at least one of the scale factor or the slot aggregation factor.

### CROSS REFERENCE TO RELATED APPLICATION(S)

This application claims the benefit of U.S. Provisional Application Ser. No. 63/023,227, entitled “METHOD AND APPARATUS FOR DETERMINING MODIFIED TB SIZE FOR SLOT AGGREGATION” and filed on May 11, 2020, the disclosure of which is expressly incorporated by reference herein in its entirety.

### BACKGROUND

### Technical Field

The present disclosure generally relates to communication systems, and more particularly, to the sizing of transport blocks used for uplink transmissions from a user equipment to a base station.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A user equipment (UE) in a limited coverage scenario, such as near a cell edge, may experience some loss of data reliability, increase in block error rate (BLER), or otherwise diminished link budget. To accommodate such conditions, and conform to the link budget, the UE in the limited coverage scenario may attempt to reduce the size of transport blocks (TBs) on which payload bits from higher layer protocol data units (PDUs) are mapped. The smaller TB sizing is often insufficient to accommodate all of the payload bits, when aggregated with header bits and/or other obligatory control information that is to accompany the payload bits in transmission. One approach to this issue is segmentation of PDUs so that a respective subset of payload bits is assigned to each of a set of TBs that, in the aggregate, carry all the payload bits in uplink transmission.

Dividing PDUs in this way does often enable contemporaneous transmission of all payload bits of one higher layer PDU. However, such segmentation may necessarily increase the amount of control information transmitted, e.g., as each segment will include a respective header to be accommodated in association with TB transmission. Furthermore, each segment transmitted on a respective TB may be assigned to a hybrid automatic repeat request (HARD) process, which inherently effects increased overhead with respect to processing power, over-the-air signaling, and the like.

Thus, the attempt to satisfy a lower link budget while in a cover-limited scenario may have some ancillary effects tending to increase the load on both the UE and the network (e.g., base station and air interface). Such increases in overhead may adversely affect the effective code rate with which the payload bits are transmitted, and perhaps negate (or at least appreciably reduce) any benefit derived from the smaller TB size. Therefore, a need exists to improve uplink transmission from a UE to the network in a coverage-limited scenario.

The present disclosure provides various techniques and solutions for improving the reliability and performance of uplink transmissions by a UE located near a cell edge or other limited coverage situation. In particular, aspects of the present disclosure describe a UE configured with the opposite approach to satisfying a lower link budget: the UE may scale up or increase TB size for uplink transmission. Such an approach may overcome some or all of the drawbacks that accompany smaller TB sizes.

For example, increasing TB size may have the desirable effect of reducing the amount of signaling and HARQ processes recruited to provide feedback, e.g., as fewer TBs may be used to communicate the same number of bits. Such increases may be of particular benefit to UEs near a cell edge or otherwise in limited coverage, as the increased TB size may lead to a proportionate increase in data reliability and/or improved spectral efficiency. Moreover, the benefits of the larger TB size may be obtainable without significantly affecting the effective code rate—that is, a larger sized TB including all payload bits may have an effective code rate that is comparable to multiple smaller sized TBs over which a payload is segmented.

In a first aspect of the disclosure, a first method, a first computer-readable medium, and a first apparatus are provided. The first apparatus may be a UE or a component thereof, which may be configured to determine a size of a TB for transmission to a base station based on signaling received from the base station for configuration of at least one of a scale factor or a slot aggregation factor associated with TB size. The first apparatus may be further configured to transmit, to the base station, information on the TB in at least one slot, the TB being of the determined size.

In a second aspect of the disclosure, a second method, a second computer-readable medium, and a second apparatus are provided. The second apparatus may be a base station or a component thereof, which may be configured to transmit, to a UE, signaling for configuration of at least one of a scale factor or a slot aggregation factor associated with a TB size to be used by the UE for transmission. The second apparatus may be further configured to receive, from the UE, information on at least one TB having a size that is based on at least one of the scale factor or the slot aggregation factor.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink channels within a subframe, in accordance with various aspects of the present disclosure.

FIG. 3 is a diagram illustrating an example of a base station and user equipment (UE) in an access network.

FIG. 4 is a call flow diagram illustrating an example flow of wireless communications and operations by a base station and a UE.

FIG. 5 is a flowchart of an example method of wireless communication by a UE.

FIG. 6 is a flowchart of an example method of wireless communication of a base station.

FIG. 7 is a diagram illustrating an example of a hardware implementation for an example apparatus.

FIG. 8 is another diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, computer-executable code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

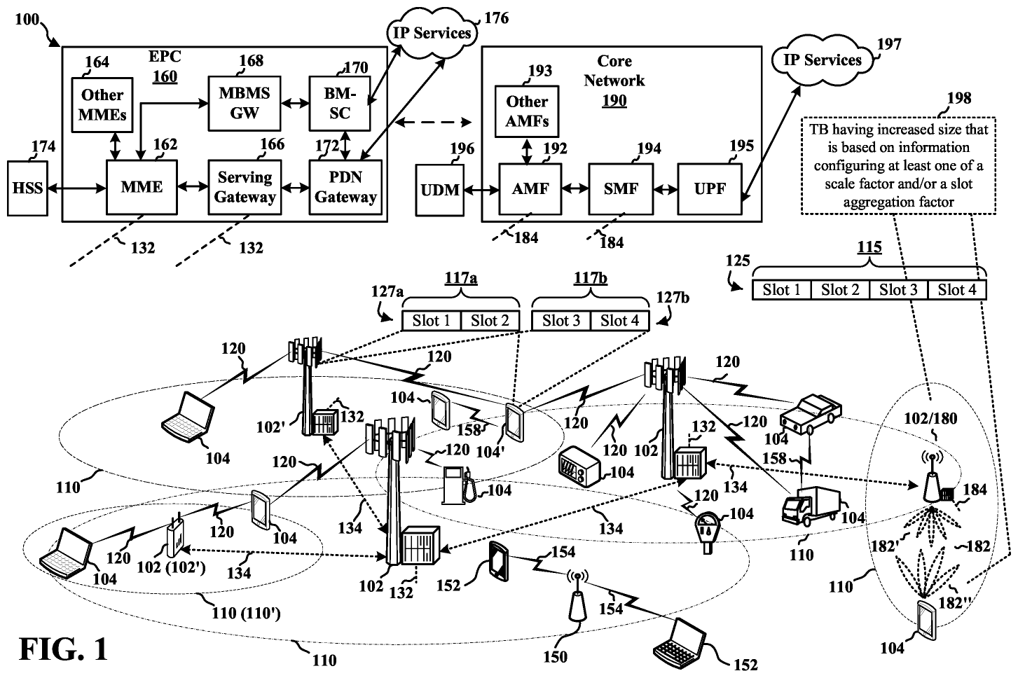

FIG. 1 is a diagram illustrating an example of a wireless communications system and an access network 100. The wireless communications system (also referred to as a wireless wide area network (WWAN)) includes base stations 102, user equipment (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR), which may be collectively referred to as Next Generation radio access network (RAN) (NG-RAN), may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless. At least some of the base stations 102 may be configured for integrated access and backhaul (IAB). Accordingly, such base stations may wirelessly communicate with other such base stations. For example, at least some of the base stations 102 configured for IAB may have a split architecture that includes at least one of a central unit (CU), a distributed unit (DU), a radio unit (RU), a remote radio head (RRH), and/or a remote unit, some or all of which may be collocated or distributed and/or may communicate with one another. In some configurations of such a split architecture, the CU may implement some or all functionality of a radio resource control (RRC) layer, whereas the DU may implement some or all of the functionality of a radio link control (RLC) layer.

Illustratively, some of the base stations 102 configured for IAB may communicate through a respective CU with a DU of an IAB donor node or other parent IAB node (e.g., a base station), and further, may communicate through a respective DU with child IAB nodes (e.g., other base stations) and/or one or more of the UEs 104. One or more of the base stations 102 configured for IAB may be an IAB donor connected through a CU with at least one of the EPC 160 and/or the core network 190. In so doing, a base station 102 operating as an IAB donor may provide a link to the one of the EPC 160 or the core network 190 for one or more UEs and/or other IAB nodes, which may be directly or indirectly connected (e.g., separated from an IAB donor by more than one hop) with the IAB donor. In the context of communicating with the EPC 160 or the core network 190, both the UEs and IAB nodes may communicate with a DU of an IAB donor. In some additional aspects, one or more of the base stations 102 may be configured with connectivity in an open RAN (ORAN) and/or a virtualized RAN (VRAN), which may be enabled through at least one respective CU, DU, RU, RRH, and/or remote unit.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use multiple-input and multiple-output (MIMO) antenna technology, including spatial multiplexing, beamforming, and/or transmit diversity. The communication links 120 may be through one or more component carriers (CCs). The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (e.g., x CCs) used for transmission in each direction. The CCs may or may not be adjacent to each other. Allocation of CCs may be asymmetric with respect to downlink and uplink (e.g., more or fewer CCs may be allocated for downlink than for uplink).

The CCs may include a primary CC and one or more secondary CCs. A primary CC may be referred to as a primary cell (PCell) and each secondary CC may be referred to as a secondary cell (SCell). The PCell may also be referred to as a “serving cell” when the UE is known both to a base station at the access network level and to at least one core network entity (e.g., AMF and/or MIME) at the core network level, and the UE is configured to receive downlink control information in the access network (e.g., the UE may be in an RRC Connected state). In some instances in which carrier aggregation is configured for the UE, each of the PCell and the one or more SCells may be a serving cell.

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to, and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mmWave” or simply “mmW”) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, radio access and other wireless networks may establish timing structures to discretely divide wireless channels into respective sets of time resources. The time resources may separately identifiable, and therefore, transmissions on wireless channels can be multiplexed in the time domain. Some radio access or other wireless technologies may refer to the duration that a transmission is on a radio or other wireless communications link in terms of a transmission time interval (TTI).

Illustratively, a TTI may be available as a scheduling unit, e.g., for synchronized or coordinated communication. For example, a TTI may be used in scheduling the transfer of transport blocks (TBs) between a medium access control (MAC) layer and a physical (PHY) layer of a device. One or two (or another number) of TBs may be transferred between the MAC and PHY layers of a device for each TTI. Some releases of the Long Term Evolution (LTE) radio access technology (RAT) have fixed a TTI at a duration of one (1) millisecond (ms) for transmissions on the radio air interface. Some releases of the 5G New Radio (NR) RAT, however, allow for a variable duration TTI, e.g., enabled through different subcarrier spacing configurations.

The TTIs may be used for acknowledgement (ACK)/negative (or non-) acknowledgement (NACK) feedback mechanisms, such as hybrid automatic repeat request (HARQ) implemented as the MAC layer. While such feedback mechanisms may improve data protection and reduce the incidents of lost or irrecoverable data (e.g., where the transmission and all retransmissions of a set of bits are entirely lost), some amount of latency overhead is incurred in waiting for ACK feedback on a HARQ process.

Approaches to reducing this latency overhead may include TTI bundling and/or slot aggregation. TTI bundling may refer to “bundling” a transmission (e.g., at least one TB) with one or more corresponding retransmissions (e.g., a TB with the same information but having a different set of error correction/detection bits) over a set of consecutive TTIs, which are transmitted irrespective of HARQ feedback on the associated HARQ process. Such an approach may be particularly beneficial for UEs operating near a cell edge or otherwise having limited (uplink) coverage, as a UE would not be wait for HARQ feedback before sending a retransmissions, and further, the base station may send ACK or NACK feedback for the bundle of transmission/retransmission(s) as a whole (rather than individually for each TTI).

Similar to TTI bundling, slot aggregation may include scheduling a transmission over one or more aggregated slots, which then may be associated with the one HARQ process for feedback purposes. In some implementations, a transmission (e.g., at least one TB) may be aggregated with one or more retransmissions over a set of contiguous (or consecutive) slots or non-contiguous (or non-consecutive) slots. In some other implementations, a transmission may include bits that are scheduled over multiple contiguous or non-contiguous slots, which may include data without the retransmission protection offered through TTI bundling.

Using either mechanism (or other similar mechanism), HARQ processes are utilized to a greater degree than if ACK/NACK feedback were exchanged for each individual TTI and/or retransmissions were predicated upon receiving ACK/NACK feedback for another transmission (or retransmission). Accordingly, latency inherent in the round-trip time (RTT) may be reduced, while also potentially reducing the overhead commensurate with predicating retransmissions upon ACK/NACK feedback. Such mechanisms may improve reliability and throughput for UEs in cell-edge and other coverage-limited scenarios. Further, such bundling and aggregation mechanisms may reduce the number of segments from an RLC layer.

In some aspects, a UE located within a limited coverage area, data packets may be segmented into smaller sized packets in order to fit within a link budget. Each segment of the data packets may be transmitted with a separate HARQ process. However, such segmentation may increase the amount of control information transmitted. In one configuration, slot aggregation or TTI bundling may enable an entire payload/packet to be transmitted over a span of multiple slots, e.g., four (4) slots, without necessitating any additional segmentation or increased control information transmitted.

Specifically, such TB transmission schemes may be enabled through redundancy version (RV) cycling. Briefly, RV cycling may involve cycling through different RVs according to a known pattern—e.g., RV 0, RV 2, RV 3, RV 1, potentially in slot n, slot n+1, slot n+2, slot n+3, respectively. However, repeating the same RV over multiple slots before cycling to the next RV may allow for symbol or soft combining of the bits across multiple slots, allowing aggregated slots (e.g., slots in which the same RV is used without cycling to the next) to effectively function as a single TB when decoded at the receiving base station.

By way of illustration and not limitation, a UE located at the edge of a cell or otherwise in limited coverage may be allocated an RB(s) by a base station, which may configure the modulation order of a modulation and coding scheme (MCS) as quadrature phase shift keying (QPSK) on the RB(s). Illustratively, nine (9) symbols per RB may be allocated for a data transmission on an uplink data channel, such as a physical uplink shared channel (PUSCH), and three (3) symbols may be allocated for a demodulation reference signal (DM-RS).

In the time domain of such a configuration, a slot may have a capacity to carry a number of coded bits that is equal to the product of the number of RB(s) multiplied with the number of subcarriers per RB, the number of allocated data symbols, and the number of repetitions (e.g., configured per slot on the PUSCH). Thus, with one (1) RB, twelve (12) subcarriers, nine (9) data symbols, and two (2) repetitions, a total of 1×12×9×2=216 coded bits may be transmitted per slot. Further to this illustration, the UE may obtain (e.g., lower layer(s) of the UE may obtain from higher layer(s)) an adaptive multi-rate (AMR) payload configured with robust header compression (RoHC) having a total size of 328 bits.

The 328 total bits is larger than the 216 coded bits configured to be transmitted per slot. One option the UE may have for transmitting the AMR payload and RoHC header may include subdividing the payload into two (2) payloads, e.g., of 164 bits each when there are 328 bits total, and sending the two payload subdivisions as two separate TBs. Accounting for the overhead commensurate with carrying information from multiple other layers, such as the RLC, the medium access control (MAC), and the packet data convergence (PDCP) layers of layer 2 (L2), which may be five (5) bytes or forty (40) bits, each of the two TBs may carry a number of bits equal to the sum of the packet overhead added with the subdivided payload size, or 40+164=204 bits. Using two (2) repetitions with RV cycling, the effective code rate for transmitting the AMR payload with RoHC when subdivided over two (2) TBs may be equal to the quotient of the number of bits per TB divided by the number of coded bits available for transmission in each slot, or 204÷216÷2=0.4722.

FIG. 1 illustrates such an example in which one UE 104′ may transmit some uplink transmission to a base station 102′ on TBs configured with a relatively small size or short duration in order to accommodate a poor link budget. Thus, two bit segments 127a, 127b may be separated over two TBs 117a, 117b. Each of the two bit segments 127a, 127b may include a respective set of the 204 bits and respective error detection code (EDC) and/or error correction code (ECC) (EDC/ECC) bits, such as parity bits. The first bit segment 127a may be carried in the first TB 117a in the first two slots (2) as two repetitions with RV cycling, and similarly, the second segment 127b may be carried in the second TB 117b in the second two (2) slots as two repetitions with RV cycling of different bits (and therefore having different EDC/ECC bits). This segmentation over two TBs 117a, 117b may involve greater overhead than that of a single TB with respect to HARQ processing and/or other time- or reliability-sensitive operations.

Therefore, another option may be for the UE to send the 328 bits as a single TB, but over four (4) repetitions with RV cycling. As illustrated in FIG. 1, the UE 104 may transmit all AMR payload bits 125 (with RoHC) as a single TB 115 over four (4) slots, with one repetition per slot and the RV being consistent across all four repetitions/slots. While the first transmission (a subset of the AMR payload bits 125 in the first slot, Slot 1) may not be decodable, due to the size of the TB 115 exceeding the number of coded bits configured for a slot (e.g., 216 bits per slots), RV cycling may enable all the bits 125 across all four (4) slots to be decoded as a single TB 115.

In effect, TTI bundling or slot aggregation may be leveraged to configure one TB having a size equal to at least a sum of the number of bits for the transmission and the header, or 328+40=368. Such a configuration may occupy up to four (4) (or more) repetitions with RV cycling, and therefore, the effective code rate for transmitting the AMR payload with RoHC as a single TB over four (4) slots may be equal to the quotient of the number of bits one the single TB divided by the number of coded bits available for transmission in each slot, or 328÷216÷4=0.4259. This effective code rate for the entire TB—e.g., the TB carrying all AMR payload bits with RoHC over four (4) slots having the same RV—may be comparable to that of the smaller sized TBs while avoiding or reducing the disadvantageous adjuncts of increased HARQ usage, increased and redundant signaling, increased processor loads and network congestion, and so forth caused by the smaller TB size.

This larger TB may be beneficial in terms of reducing latency and other overhead on the air interface, for example, because spectral efficiency may be improved relative to smaller TB size. As separating the AMR payload with RoHC across two (2) TBs demands two (2) different sets of the EDC/ECC bits, and two different headers from each of the one or more L2 layers (e.g., MAC, RLC, PDCP), the overhead may be increased when segmenting a payload due at least in part to the recruitment of additional HARQ processes for the additional TBs, which may involve additional processing power for the additional HARQ processes and additional signaling of ACK/NACK feedback. In other words, larger TB sizes may be beneficial in terms of device performance and network congestion on the air interface, as the amount of control and/or other overhead signaling that is encoded, transmitted, decoded, etc. for relatively larger TB sizes is appreciably decreased in comparison with relatively smaller TB sizes.

Quantifiably, channel performance may be measured as signal energy per bit to average noise ratio (E_{b}/Nₒ) or a signal energy per symbol to average noise ratio (Eₛ/Nₒ). The E_{b}/Nₒ (or Eₛ/Nₒ) needed to achieve a target block error rate (BLER) of 10⁻² and 10⁻⁵ for a modulation order of 4 quadrature amplitude modulation (4QAM), e.g., as evaluated on a tapped delay line channel (TDLC), may be relative to the bit size of a payload. For payloads having smaller bit sizes then, the E_{b}/Nₒ to achieve a target BLER is inversely proportional to TB size. That is, the smaller the payload on a TB, the higher the E_{b}/Nₒ needed to reach a target BLER for that data payload. Therefore, larger TB sizes necessarily contribute to increased data reliability, and so increasing or scaling up a TB size for uplink transmissions may result in a higher or comparable effective code rate, lower E_{b}/Nₒ (or Eₛ/N₀), and generally more reliable uplink communication.

Accordingly, the present disclosure describes various techniques and solutions to scaling up or increasing TB size. Such increases may be particularly valuable to UEs near a cell edge or otherwise in limited coverage, as the increased TB sizes may lead to proportionate increases in data reliability. Coupled with lower signaling overhead and improved spectral efficiency, both UE and network (e.g., base station) communication and performance may be improved over that using smaller TB sizes.

In various aspects, a UE 104, or a component thereof, may be configured to determine a size of a TB for transmission to the base station 102/180 based on signaling received from the base station 102/180 for configuration of at least one of a scale factor or a slot aggregation factor associated with TB size. The UE 104 may be further configured to transmit, to the base station 102/180, information on the TB in at least one slot, with the TB being of the determined size (198), which may be scaled up or increased from that of another TB size.

Correspondingly, the base station 102/180 may be configured to transmit, to the UE 104, the signaling for configuration of the at least one of the scale factor or the slot aggregation factor associated with a TB size to be used by the UE 104 for transmission. The base station 102/180 may be further configured to receive, from the UE 104, information on at least one TB having a size (e.g., scaled up or increased size) that is based on at least one of the scale factor or the slot aggregation factor (198).

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

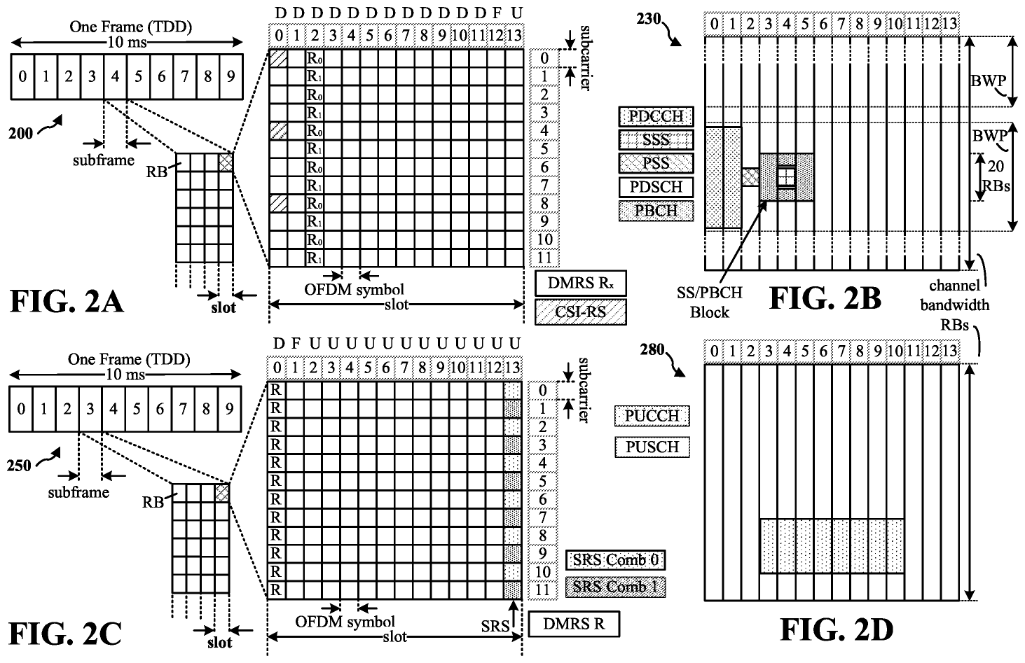

FIG. 2A is a diagram 200 illustrating an example of a first subframe within a 5G NR frame structure. FIG. 2B is a diagram 230 illustrating an example of downlink channels within a 5G NR subframe. FIG. 2C is a diagram 250 illustrating an example of a second subframe within a 5G NR frame structure. FIG. 2D is a diagram 280 illustrating an example of uplink channels within a 5G NR subframe. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 2A, 2C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry at least one pilot and/or reference signal (RS) for the UE. In some configurations, an RS may include at least one demodulation RS (DM-RS) (indicated as Rₓ for one particular configuration, where 100x is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 2B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the uplink.

FIG. 2D illustrates an example of various uplink channels within a subframe of a frame. The PUCCH may be located as indicated in one configuration. The PUCCH carries uplink control information (UCI), which may include a scheduling request (SR), a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

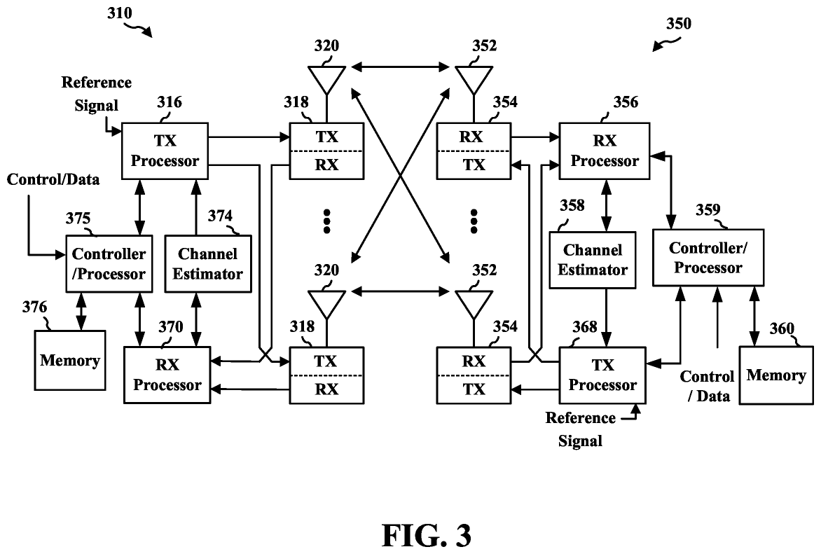

FIG. 3 is a block diagram of a base station 310 in communication with a UE 350 in an access network. In the downlink, IP packets from the EPC 160 may be provided to a controller/processor 375. The controller/processor 375 implements L2 and Layer 3 (L3) functionality. L3 includes an RRC layer, and L2 includes a service data adaptation protocol (SDAP) layer, a PDCP layer, an RLC layer, and a MAC layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

The transmit (TX) processor 316 and the receive (RX) processor 370 implement Layer 1 (L1) functionality associated with various signal processing functions. L1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate a radio frequency (RF) carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement L1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal may include a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements L3 and L2 functionality.

The controller/processor 359 can be associated with a memory 360 that stores program codes and data. The memory 360 may be referred to as a computer-readable medium. In the uplink, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the downlink transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The uplink transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the uplink, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In some aspects, at least one of the TX processor 368, the RX processor 356, and the controller/processor 359 may be configured to perform aspects in connection with (198) of FIG. 1.

In some other aspects, at least one of the TX processor 316, the RX processor 370, and the controller/processor 375 may be configured to perform aspects in connection with (198) of FIG. 1.

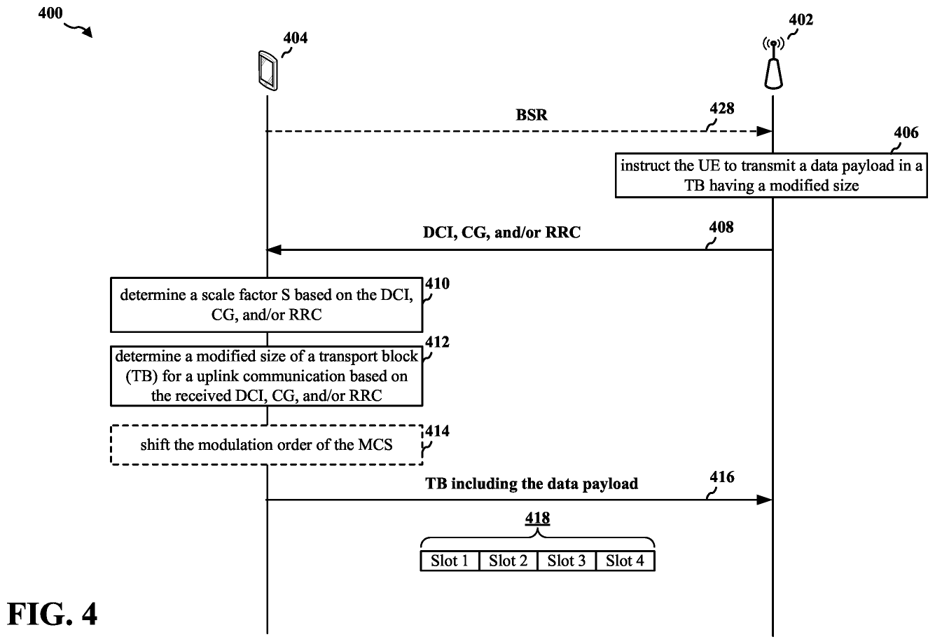

FIG. 4 is a call flow diagram 400 illustrating an example flow of wireless communications and operations by a base station 402 and a UE 404. The base station 402 may determine to instruct the UE 404 to transmit a data payload in a TB having a modified size 406. The determination of the base station to instruct the UE 404 to transmit a data payload in the TB having the modified size may be based on a BSR received from the UE 404. Accordingly, the base station 402 may receive a BSR 428 from the UE 404, and based on the received BSR, may determine to instruct the UE 404 to transmit a data payload in a TB having a modified size.

For example, the BSR may inform the base station 402 of an amount of data pending uplink transmission from the UE 404, and potentially, a packet structure of such data. Thus, the base station 402 may be select or determine a TB size that is suitable for use by the UE 404, e.g., to enable the UE 404 to include the payload bits of each individual packet on a single respective TB. The base station 402 may calculate the size of such a TB relative to the currently configured TB size used by the UE 404 for uplink transmissions to the base station 402. The base station 402 may identify this calculated TB size in terms of a scale factor or a slot aggregation factor, which may refer to the number of repetitions over which contiguous slots may be configured in order for RV cycling to be used on the contiguous slots so such slots with the same RV may be treated as a single TB. The scale factor or slot aggregation factor may be greater than or equal to one (1). The scale factor or the slot aggregation factor may be inapplicable to downlink signaling from the base station 402 to the UE 404, as TB sizes may benefit base station to UE downlink transmissions by being downscaled or reduced.

The base station 402 may transmit a signal 408 indicating at least one of an MCS, a scale factor S, a number of resources assigned per slot, or a slot aggregation factor to the UE 404. In some aspects, the signal 408 may include signaling from the base station 402 for configuration of at least one of a scale factor or a slot aggregation factor associated with TB size. The information may indicate at least one of a modulation order or a coding rate, and the scale factor may be determined by the UE 404 based on the at least one of the modulation order or the coding rate.

The signal 408 may include DCI, a configured grant (CG), a MAC control element (CE), and/or an RRC message. In other words, the base station 402 may transmit a signal to the UE 404 including DCI, CG, MAC CE, and/or RRC message, indicating at least one of the MCS, the scale factor S, the number of resources assigned per slot, or the slot aggregation factor.

In some other aspects, the signaling from the base station 402 includes an index value identifying an entry in a table that indicates the scale factor using the index value. For example, the UE 404 may receive, from the base station 402, other signaling for configuration of a set of entries in the table, each entry of the set of entries including at least a respective index value corresponding with a respective scale factor greater than or equal to one (1).

The UE 404 may determine a size of the TB based on the signal received from the base station 402. First, the UE 404 may determine an uplink TB size scale factor S (hereinafter scale factor S) 410 to determine the size of the TB. The scale factor S is different from the size scaling factor assigned for certain downlink configurations (e.g., paging and random access configurations). The scale factor S may have a value greater than or equal to 1. The signal may include the value of the scale factor S and/or predefined indicator signaling the scale factor S. For example, Table 1 illustrates an example of the scale factor S. The scale factor S may be signaled by the base station 402 to the UE 404 and the UE 404 might be driven by the DCI, the CG (e.g., MAC-CE), and/or the RRC message. That is, the base station 402 may include a bit value in a TB scale field of the signal to indicate the scale factor S to the UE 404 using the DCI, the CG (e.g., MAC-CE), and/or RRC message.

TABLE 1
example scale factor table for modified uplink TB size determination.

| TB Scale Field | Scale Factor S |
|---|---|
| 00 | 1 |
| 01 | 2 |
| 10 | 4 |
| 11 | reserved |

The activation/deactivation of the UE 404 to determine (and use) a scale factor S may be controlled semi-statically for a number of uplink slots or controlled dynamically in response to a activation/deactivation code transmitted from the base station 402. Particularly, the base station 402 may transmit the DCI, the CG, and/or RRC message to the UE 404 to semi-statically or dynamically instruct the UE 404 to use the modified TB size for uplink communication. For example, the base station 402 may semi-statically instruct the UE 404 to determine the scale factor S and use the scale factor S for a set number of subsequent uplink communication slots. In other aspects, the new scale factor S may be used until an explicit deactivation is received. The base station 402 may also dynamically activate or deactivate the UE 404 to determine the scale factor S and use the scale factor S for a set number of subsequent uplink communication slots. Upon deactivation, the UE 404 may revert to determining the size of the TB not based on the scale factor S.

The UE 404 may choose the scale factor S based on a predefined rule agreed in advance by the UE 404 and the base station 402 based on the DCI, the CG, and/or the RRC message received from the base station 402. For example, the UE 404 may be configured to determine the scale value S and determine a modified TB size for uplink transmission when the number of RBs assigned to a UE 404 is below a predefined RB threshold value. The UE 404 may be configured to determine the scale value S and determine a modified TB size for uplink transmission when the assigned MCS has a modulation order below a predefined RB threshold value (e.g. restrict its use to only MCS with QPSK modulation). Also, the UE 404 may determine the scale value S as equal to the number of repetitions for data configured in the DCI received from the base station 402 (e.g., pusch-AggregationFactor). The predetermined rule may also be any combination of the above in any form.

The UE 404 may use the scale factor S and perform the following operations to determine the modified size of TB 412. When determining the modified TB size, the UE 404 may utilize the following information: the number of symbols and RBs assigned to the UE, the DM-RS overhead, other overhead, the number of layers, and/or the coding rate.

First, the UE 404 may determine a number of REs N′_{RE} allocated for the PUSCH within a PRB:

N_{RE}′=N_{SC}^{RB}·N_{symb}^{sh}−N_{DMRS}^{PRB}−Nₒₕ^{PRB},

where N_{symb}^{sh} and N_{SC}^{RB} are the number of symbols and RBs allocated to the PUSCH, N_{DMRS}^{PRB} is the number of resources assigned for DM-RS overhead factor, and Nₒₕ^{PRB} is an additional overhead factor.

The UE 404 may determine the total number of REs allocated to PUSCH (N_{RE}):

N_{RE}=n_{prb}*min(156,N′_{RE}),

where n_{prb} denotes the total number of PRBs assigned to the UE 404.

The UE 404 then may determine a modified intermediate number of information bits (N_{info}):

N_{info}=S*N_{RE}*R*Qₘ*v,

where S is the scale factor, R is the coding rate, Qₘ is the modulation order and v is the number of layers.

Upon obtaining the modified intermediate number of information bits N_{info}, the UE 404 may determine the modified TB size according to one of two approaches, the selection of the approach being based on whether N_{info} is equal to or less than 3824 (N_{info}≤3824).

Where N_{info} is equal to or less than 3824, the UE 404 may calculate a quantized intermediate number of information bits N′_{info}:

$${N}_{info}^{′} = max ( 24 , {2}^{n} * ⌊ \frac{{N}_{info}}{{2}^{n}} ⌋ ) ,$$

where n=max(3, └log₂(N_{info})┘)−6. Then the UE 404 may use the quantized intermediate number of information bits N′_{info} as an index value to find the TB size from the Table 2.

TABLE 2
example table for TB size with N_{info} ≤ 3824.

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |

However, when N_{info} is not equal to or less than 3824—i.e., when N_{info} is greater than 3824, the UE may calculate the N′_{info} according to:

$${N}_{info}^{′} = {2}^{n} \times round ( ⌊ \frac{{N}_{info} - 24}{{2}^{n}} ⌋ ) ,$$

where n=└log₂ (N_{info}−24)┘−5.

Further, if the coding rate R is equal to or less than ¼ (R≤¼), then the UE 404 may determine the TB size according to the formula:

$$TBS = 8 * C * ⌈ \frac{{N}_{info}^{′} + 24}{8 * C} ⌉ - 24 , where C = ⌈ \frac{{N}_{info}^{′} + 24}{3816} ⌉ .$$

If the coding rate R is not equal to or less than ¼ (R>¼), then the UE 404 may determine that the TB size (TBS):

$$TBS = 8 * ⌈ \frac{{N}_{info}^{′} + 24}{8} ⌉ - 24 , when {N}_{info}^{′} < 8424 , or$$

$$TBS = 8 * C * ⌈ \frac{{N}_{info}^{′} + 24}{8 * C} ⌉ - 24 , when {N}_{info}^{′} \geq 8424 , \\ where C = ⌈ \frac{{N}_{info}^{′} + 24}{8424} ⌉ .$$

In some aspects, using the scale factor S may increase an effective code rate per slot to a value greater than 1. However, each MCS may have a coding rate limitation. For example, the coding rate may be limited to 0.66 for a MCS restricted to QPSK. Accordingly, the UE 404 may shift the modulation order 414 to support a larger TB size selected using the scale factor S. The MCS specifies the modulation order and the coding scheme. Accordingly, the UE 404 is configured to code and modulate the data according to the MCS. The modulation order may be defined by a parameter labeled Qm in a data structure (e.g., table) associated with the MCS. The relationship between the modulation order and the Qm parameter may be given by the same or different data structure, an example of which is illustrated in Table 3:

TABLE 3
MCS modulation order

| Qm | Modulation order |
|---|---|
| 2 | QPSK |
| 4 | 16 QAM |
| 6 | 64 QAM |
| 8 | 256 QAM |

In one configuration, the UE 404 may shift the modulation order for determining the size of the TB and/or transmitting the TB. Particularly, the base station 402 may transmit an instruction in the signal, such as the DCI, the CG, and/or RRC message, to the UE 404 to shift the modulation order to a higher modulation order to determining the size of the TB and/or shift the modulation order back to the lower modulation order when transmitting the TB over the uplink communication.

In one configuration, the base station 402 may instruct the UE 404 to use an MCS in the reserved range defined in the MCS index table. Particularly, the UE 404 may be instructed to transmit the TB at a first modulation order and retransmit the TB at a second modulation order of the MCS in the reserved range, lower than the first modulation order. For example, the UE 404 may first transmit the TB encoded and transmitted using 16QAM MCS to the base station 402, and retransmit the TB encoded and transmitted using QPSK. Accordingly, the UE 404 may first try transmitting the first TB over the higher modulation order. When the communication condition is too noisy or has too much loss, there is a high chance that the first transmission fails due to noise/interference. However, the first transmission is independently decodable. The retransmission of the TB using the lower code rate second modulation order may compensate for the noisy channel conditions enabling the TB to be successfully received at the base station 402. Accordingly, the UE 404 may reduce the likelihood of violating packet delay budgets for certain types of transmissions, e.g., voice call transmissions.

In another configuration, the base station 402 may add a bit in the DCI, the CG, and/or the RRC message to instruct the UE 404 to downshift the modulation order MCS for uplink transmission. For example, the base station 402 may generate the DCI to include 5 bits indicating the MCS, and include an additional bit to indicate the correction/modification. The UE 404, in response to receiving the DCI, the CG, and/or the RRC message, may determine the TB size based on the first modulation order of the MCS as instructed, and shift the modulation order to a second modulation order lower than the first modulation order, and retransmit the TB using the second modulation order.

Particularly, the UE determines the size of the TB based on the MCS having a first modulation order provided in the DCI, the CG, and/or the RRC message. Once the TB size is determined and the encoding is complete, UE 404 may downshift the modulation order to a second modulation order and map the encoded bits to modulation symbols at the second modulation order. For example, the base station 402 may transmit the DCI to the UE 404 signaling the 16QAM MCS with the correction/modification bit. The UE 404 may choose the TB size and encode the data payload based on the 16QAM MCS. Then, the UE 404 may downshift the modulation order to QPSK, map the encoded bits to modulation symbols of QPSK, and transmit the TB at the modulation order of QPSK. Accordingly, the base station 402 may instruct the UE to use a higher than normal value for MCS, so that a larger TB size can be chosen for transmitting the data.

The UE 404 may transmit the TB 416 to the base station 402 over the uplink transmission in a sequence of uplink slots 418. The base station 402 may receive the uplink transmission from the UE 404 and, initially, may be unable to decode the first slot. However, the base station 402 may store (e.g., buffer) bits of the first slot and, when the base station 402 receives the subsequent slots, the base station 402 may perform soft or symbol combining to decode the payload included therein, e.g., according to the RV cycling with which the bits are encoded in the sequence of slots.

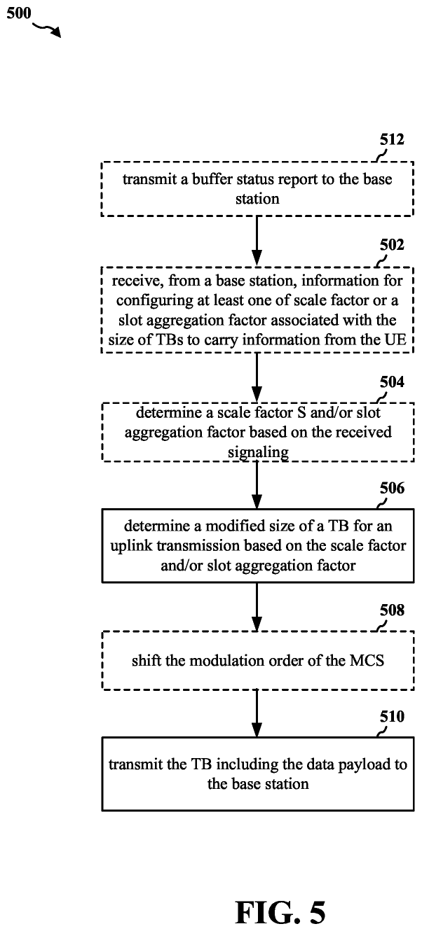

FIG. 5 is a flow chart 500 of a method of wireless communication. The method may be performed by a UE (e.g., the UE 104, 350, 404), an apparatus (e.g., the apparatus 702), and/or any component thereat. According to various aspects, one or more of the illustrated blocks may be transposed, omitted, and/or contemporaneously performed.

At 502, the UE may receive signaling from the base station for configuration of at least one of a scale factor or a slot aggregation factor associated with TB size. For example, the signaling may include DCI, a CG, a MAC CE, and/or an RRC message from the base station. The DCI may include semi-static or dynamic instruction from the base station to determine a modified TB size for an uplink transmission, and/or to shift the modulation order of the MCS. The information may indicate at least one of a modulation order or a coding rate, and the scale factor may be determined by the UE based on the at least one of the modulation order or the coding rate.

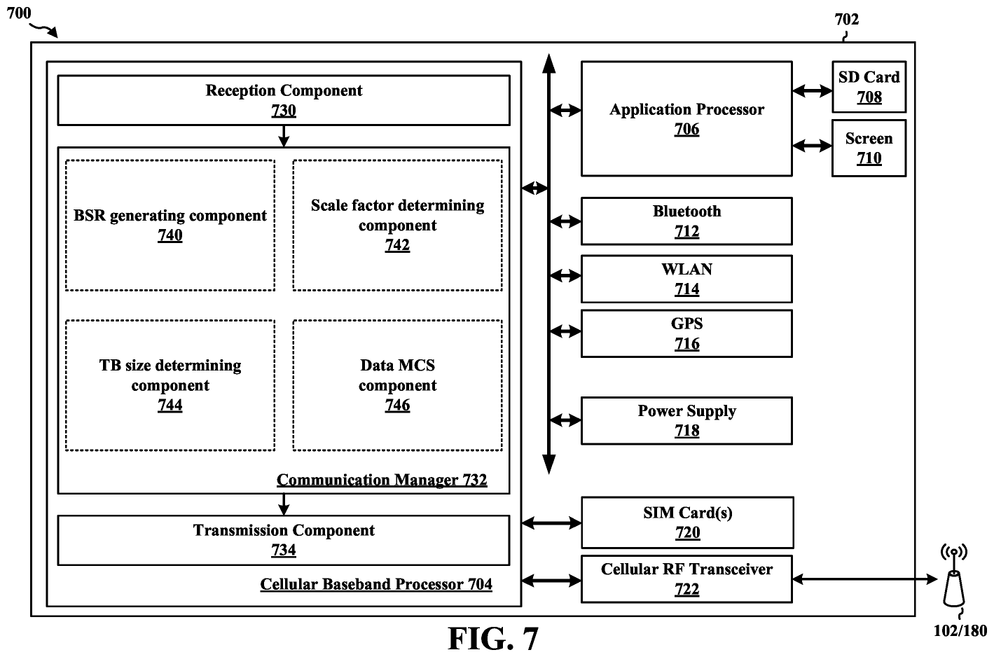

In the context of FIG. 4, 502 may include the UE 404 receiving the signaling 408 including at least one of the DCI, a CG, MAC CE, and/or an RRC message from the base station 402. In the context of FIG. 7, 502 may be performed by a reception component 730 of FIG. 7.

At 504, the UE may determine the scale factor S based on the DCI, the CG, and/or the RRC message received from the base station. In some aspects, the signaling from the base station includes an index value identifying an entry in a table that indicates the scale factor using the index value. For example, the UE may receive, from the base station, other signaling for configuration of a set of entries in the table, each entry of the set of entries including at least a respective index value corresponding with a respective scale factor greater than or equal to one (1).

The scale factor and/or slot aggregation factor may be associated with increasing an effective code rate from another effective code rate associated with another TB size. The scale factor and/or slot aggregation factor may be inapplicable to downlink signaling from the base station to the UE. For example, a different table may be configured to modify the sizes of TBs on the downlink, and the downlink scale factors may be configured to reduce the TB size, and the downlink scalar values may be less than or equal to one (1). Conversely, the scale factor and/or slot aggregation factor may be applicable to uplink transmission and may be greater than or equal to one (1).

The UE may choose the scale factor S based on a predefined rule agreed in advance by the UE and the base station based on the DCI, the CG, and/or the RRC message received from the base station. For example, the UE may be configured to determine the scale value S and determine a modified TB size for uplink transmission when the number of RBs assigned to a UE is below a predefined RB threshold value. The UE may be configured to determine the scale value S and determine a modified TB size for uplink transmission when the assigned MCS has a modulation order below a predefined RB threshold value. In addition, the UE may determine the scale value S equal to the number of repetitions for data configured in the DCI received from the base station (e.g., pusch-AggregationFactor). The predetermined rule may also be any combination of the above in any form.

In the context of FIG. 4, 504 may include the UE 404 determining the scale factor S based on the signaling 408 of the DCI, the CG, and/or the RRC message received from the base station 402. In the context of FIG. 7, 504 may be performed by a scale factor determining component 742 of FIG. 7.

At 506, the UE may determine the modified size of the TB for the uplink transmission based on the received signaling. For example, the signaling may include the DCI, CG, and/or RRC message. For example, the UE may determine a size of a TB for transmission to the base station based on signaling received from the base station for configuration of at least one of a scale factor or a slot aggregation factor associated with TB size. The UE may determine the size of the TB based on the number of symbols and RBs assigned to the UE, the DM-RS overhead, other overhead, the number of layers, and/or the coding rate instructed in the DCI, the CG, and/or the RRC message received from the base station. In some aspects, the UE may obtain a set of intermediate informational bits by multiplying a set of intermediate informational bits that is based on the product of the scale factor multiplied with a number of layers for transmitting the information, a coding rate for transmitting the information, a modulation order for transmitting the information, and a number of REs allocated to transmitting the information. The UE may then compare the set of intermediate informational bits with at least one threshold to determine the approach the UE is to follow in calculating the modified TB size.

In the context of FIG. 4, 506 may include the UE 404 determining the modified size of the TB (412) for the uplink transmission based on the received signaling 408 including the DCI, the CG, and/or RRC message. In the context of FIG. 7, 506 may be performed by a TB size determining component 744 of FIG. 7.

At 508, the UE may shift the modulation order of the MCS based on the received DCI, CG, and/or RRC message to accommodate the modified size of the TB. For example, the signaling for configuration of the at least one of the scale factor or the slot aggregation factor associated with the TB size may include information indicating at least one of a modulation order or a coding rate, and the scale factor may be determined based on the at least one of the modulation order or the coding rate.

In the context of FIG. 4, 508 may include the UE 404 shifting the modulation order 414 of the MCS based on the signaling 408 including the received DCI, CG, and/or RRC message to accommodate the modified size of the TB 416. In the context of FIG. 7, 508 may be performed by a data MCS component 746 of FIG. 7.

At 510, the UE may transmit the TB including the data payload to the base station. The TB may be of the determined size—e.g., the TB may be of a scaled up or increased size relative to other TBs. For example, the TB may include multiple slots in which a set of payload bits are mapped and encoded with a redundancy version that is consistent across the multiple slots.

In the context of FIG. 4, 510 may include the UE 404 transmitting the TB of the determined (e.g., scaled up or increased) size, including the data payload, to the base station 402 on the set of sequential slots 418. In the context of FIG. 7, 510 may be performed by a data MCS component 746 and/or a transmission component 734 of FIG. 7.

In some aspects, as shown at 512, the UE may transmit a buffer status report to the base station prior to receiving the information configuring the at least one of the scale factor or the slot aggregation factor associated with the size of TBs to carry information from the UE. The base station may instruct the UE to transmit a data payload in the TB having the modified size based on the BSR, and transmit such an instruction or related to configuration to the UE in the signaling 408 including DCI, CG, and/or RRC message.

In the context of FIG. 4, 510 may include the UE 404 transmitting the BSR 428 to the base station 402, e.g., prior to the base station 402 instructing the UE 404 to transmit a data payload in a TB having a modified size 406. That is, the base station 402 may transmit, to the UE 404, the signaling 408 in response to receiving or based on the BSR 428. In the context of FIG. 7, 512 may be performed by a BSR generating component 740 and the transmission component 734 of FIG. 7.

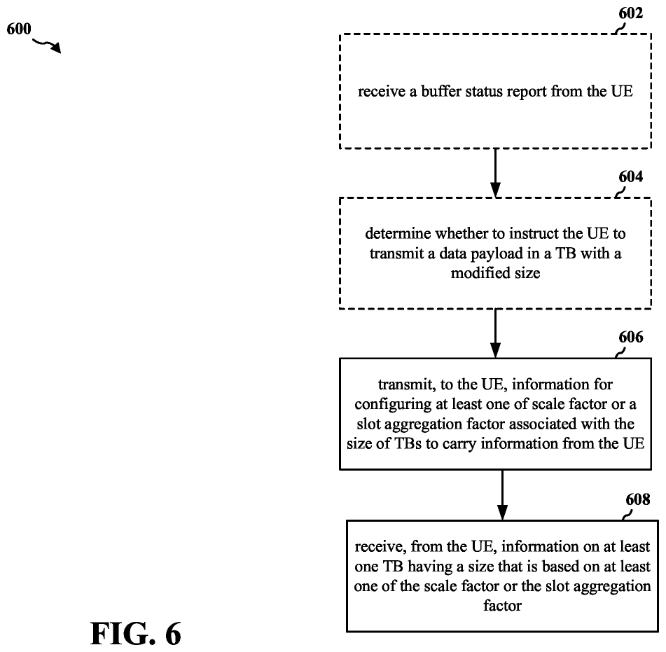

FIG. 6 is a flow chart 600 of a method of wireless communication. The method may be performed by a base station (e.g., the base station 102/180, 310, 402), an apparatus (e.g., the apparatus 802), and/or any component thereat. According to various aspects, one or more of the illustrated blocks may be transposed, omitted, and/or contemporaneously performed.

At 602, the base station may receive a BSR from the UE, which may indicate data buffered at the UE for uplink transmission. The base station may determine whether the buffered data includes one or more payloads that are of a size that can be accommodated on a single TB of a currently configured size, or if the buffered data includes or more packets of a size greater than (or equal to) the size currently configured for TBs. If the latter, the base station may determine that the UE may benefit from an increased TB size, e.g., if the base station detects that the UE is near a cell edge or in limited coverage.

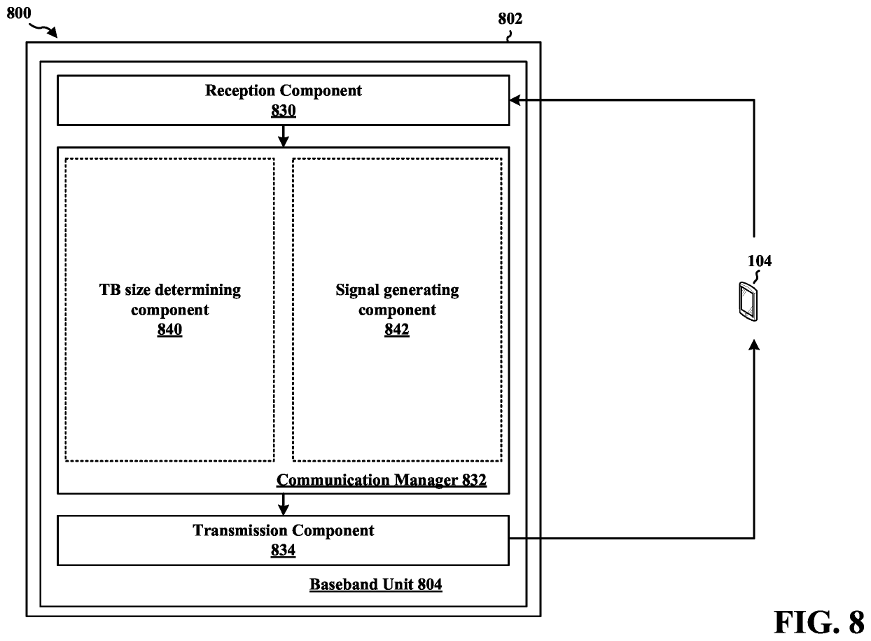

In the context of FIG. 4, 602 may include the base station 402 receiving a BSR 428 from the UE 404. In the context of FIG. 8, 606 may be performed by reception component 830 of FIG. 8.

At 604, the base station may determine to instruct the UE to transmit a data payload in a TB with a modified size based on the received BSR. The base station may determine whether the buffered data indicated by the BSR includes one or more payloads that are of a size that can be accommodated on a single TB of a currently configured size, or if the buffered data includes or more packets of a size greater than (or equal to) the size currently configured for TBs. If the latter, the base station may determine that the UE may benefit from an increased TB size, e.g., if the base station detects that the UE is near a cell edge or in limited coverage. Accordingly, the base station may determine to instruct the UE to transmit the data payload in a TB with a modified size.

In the context of FIG. 4, 604 may include the base station 402 determining to instruct the UE 404 to transmit a data payload in a TB 416 with a modified size 406. In the context of FIG. 8, 602 may be performed by a TB size determining component 840 of FIG. 8.

At 606, the base station may transmit, to the UE, signaling for configuration of at least one of a scale factor or a slot aggregation factor associated with TB size for uplink transmission by the UE. For example, the signaling may include DCI, a CG, a MAC CE, and/or an RRC message from the base station. The DCI may include semi-static or dynamic instruction from the base station to determine a modified TB size for an uplink transmission, and/or to shift the modulation order of the MCS. The information may indicate at least one of a modulation order or a coding rate, and the scale factor may be determined by the UE based on the at least one of the modulation order or the coding rate.

In some aspects, the signaling from the base station includes an index value identifying an entry in a table that indicates the scale factor using the index value. For example, the base station may transmit, to the UE, other signaling for configuration of a set of entries in the table, each entry of the set of entries including at least a respective index value corresponding with a respective scale factor greater than or equal to one (1).

The scale factor and/or slot aggregation factor may be associated with increasing an effective code rate from another effective code rate associated with another TB size. The scale factor and/or slot aggregation factor may be inapplicable to downlink signaling from the base station to the UE. For example, a different table may be configured to modify the sizes of TBs on the downlink, and the downlink scale factors may be configured to reduce the TB size, and the downlink scalar values may be less than or equal to one (1). Conversely, the scale factor and/or slot aggregation factor may be applicable to uplink transmission and may be greater than or equal to one (1).

In the context of FIG. 4, 606 may include the base station 402 transmitting, to the UE 404, signaling 408 for configuration of at least one of a scale factor or a slot aggregation factor associated with TB size for uplink transmission by the UE 404. The signaling 508 may include at least one of DCI, a CG, MAC CE, and/or an RRC message from the base station 402. In the context of FIG. 8, 606 may be performed by a signal generating component 842 and a transmission component 834 of FIG. 8.

At 608, the base station may receive, from the UE, a TB of a scaled up or increased size including a data payload—e.g., the TB may be of a scaled up or increased size relative to other TBs. For example, the TB may include multiple slots in which a set of payload bits are mapped and encoded with a redundancy version that is consistent across the multiple slots.

In the context of FIG. 4, 608 may include the base station 402 receiving, from the UE 404 on the set of sequential slots 418, the TB 416 of the determined (e.g., scaled up or increased) size. In the context of FIG. 8, 608 may be performed by a reception component 830 of FIG. 8.

FIG. 7 is a diagram 700 illustrating an example of a hardware implementation for an apparatus 702. The apparatus 702 may be a UE or similar device, or the apparatus 702 may be a component of a UE or similar device. The apparatus 702 may include a cellular baseband processor 704 (also referred to as a modem) and/or a cellular RF transceiver 722, which may be coupled together and/or integrated into the same package or module.

In some aspects, the apparatus 702 may accept or may include one or more subscriber identity modules (SIM) cards 720, which may include one or more integrated circuits, chips, or similar circuitry, and which may be removable or embedded. The one or more SIM cards 720 may carry identification and/or authentication information, such as an international mobile subscriber identity (IMSI) and/or IMSI-related key(s). Further, the apparatus 702 may include one or more of an application processor 706 coupled to a secure digital (SD) card 708 and a screen 710, a Bluetooth module 712, a wireless local area network (WLAN) module 714, a Global Positioning System (GPS) module 716, and/or a power supply 718.

The cellular baseband processor 704 communicates through the cellular RF transceiver 722 with the base station 102/180. The cellular baseband processor 704 may include a computer-readable medium/memory. The computer-readable medium/memory may be non-transitory. The cellular baseband processor 704 is responsible for general processing, including the execution of software stored on the computer-readable medium/memory. The software, when executed by the cellular baseband processor 704, causes the cellular baseband processor 704 to perform the various functions described supra. The computer-readable medium/memory may also be used for storing data that is manipulated by the cellular baseband processor 704 when executing software. The cellular baseband processor 704 further includes a reception component 730, a communication manager 732, and a transmission component 734. The communication manager 732 includes the one or more illustrated components. The components within the communication manager 732 may be stored in the computer-readable medium/memory and/or configured as hardware within the cellular baseband processor 704.

In the context of FIG. 3, the cellular baseband processor 704 may be a component of the UE 350 and may include the memory 360 and/or at least one of the TX processor 368, the RX processor 356, and/or the controller/processor 359. In one configuration, the apparatus 702 may be a modem chip and/or may be implemented as the baseband processor 704, while in another configuration, the apparatus 702 may be the entire UE (e.g., the UE 350 of FIG. 3) and may include some or all of the abovementioned modules, components, and/or circuitry illustrated in the context of the apparatus 702. In one configuration, the cellular RF transceiver 722 may be implemented as at least one of the transmitter 354TX and/or the receiver 354RX.

The reception component 730 may be configured to receive signaling on a wireless channel, such as signaling from a base station 102/180. The transmission component 734 may be configured to transmit signaling on a wireless channel, such as signaling to a base station 102/180. The communication manager 732 may coordinate or manage some or all wireless communications by the apparatus 702, including across the reception component 730 and the transmission component 734.

The reception component 730 may provide some or all data and/or control information included in received signaling to the communication manager 732, and the communication manager 732 may generate and provide some or all of the data and/or control information to be included in transmitted signaling to the transmission component 734. The communication manager 732 may include the various illustrated components, including one or more components configured to process received data and/or control information, and/or one or more components configured to generate data and/or control information for transmission.

The communication manager 732 may include, inter alia, a BSR generating component 740, a scale factor determining component 742, a TB size determining component 744, and a data MCS component 746. The BSR generating component 740 may be configured to generate and transmit (though the transmission component 734) a BSR. For example, the BSR generating component 740 may detect data in a buffer of a lower layer (e.g., L2 or L1) for uplink transmission to the base station 102/180, and may generate a BSR indicating a size of at least a portion of the buffered data. The transmission component 734 may then transmit the BSR to the base station 102/180.

The scale factor determining component 742 may be configured to determine at least one of a scale factor or a slot aggregation factor based on signaling received from the base station 102/180, e.g., as described in connection with 504 of FIG. 5. In some aspects, the signaling for configuration of the at least one of the scale factor or the slot aggregation factor associated with the TB size may include information indicating at least one of a modulation order or a coding rate, and the scale factor is determined based on the at least one of the modulation order or the coding rate. The scale factor may be greater than or equal to one (1). The scale factor may be associated with increasing an effective code rate from another effective code rate associated with another TB size. The at least one of the scale factor or the slot aggregation factor is inapplicable to downlink signaling from the base station 102/180.

In another example, the scale factor determining component 742 may determine the scale factor based on the signaling received from the base station 102/180. For example, the scale factor determining component 742 may receive (through the reception component 730) receiving, from the base station, other signaling for configuration of a set of entries in a table, each entry of the set of entries including at least a respective index value corresponding with a respective scale factor greater than or equal to one (1). The scale factor determining component 742 may then identify an entry in the table that indicates the scale factor using an index value, with the signaling from the base station including the index value.

The TB size determining component 744 may be configured to determine a size of a TB for transmission to a base station based on signaling received from the base station for configuration of at least one of a scale factor or a slot aggregation factor associated with TB size, e.g., as described in connection with 504 of FIG. 5. For example, the size of the TB may be based on a set of intermediate informational bits that is based on the product of the scale factor multiplied with a number of layers for transmitting the information, a coding rate for transmitting the information, a modulation order for transmitting the information, and a number of REs allocated to transmitting the information. The scale factor determining component 742 may calculate the set of intermediate informational bits using the aforementioned variables, and may then compare the set of intermediate informational bits with at least one threshold. The size of the TB may be determined further based on the comparing of the set of intermediate informational bits to the threshold.

The data MCS component 746 may be configured to shift an MCS of the TB having the determined size, e.g., as described in connection with 508 of FIG. 5. The transmission component 734 may be configured to transmit, to the base station 102/180, information on the TB in at least one slot, the TB being of the determined size, e.g., as described in connection with 510 of FIG. 5.

The apparatus 702 may include additional components that perform some or all of the blocks, operations, signaling, etc. of the algorithm(s) in the aforementioned call flow diagram(s) and/or flowchart(s) of FIGS. 4 and/or 5. As such, some or all of the blocks, operations, signaling, etc. in the aforementioned call flow diagram(s) and/or flowchart(s) of FIGS. 4 and/or 5 may be performed by a component and the apparatus 702 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 702, and in particular the cellular baseband processor 704, includes means for determining a size of a transport block (TB) for transmission to a base station based on signaling received from the base station for configuration of at least one of a scale factor or a slot aggregation factor associated with TB size; and means for transmitting, to the base station, information on the TB in at least one slot, the TB being of the determined size.

In one configuration, the size of the TB is further based on a set of intermediate informational bits that is based on the product of the scale factor multiplied with a number of layers for transmitting the information, a coding rate for transmitting the information, a modulation order for transmitting the information, and a number of REs allocated to transmitting the information.

In one configuration, the apparatus 702, and in particular the cellular baseband processor 704, includes means for comparing the set of intermediate informational bits with at least one threshold, and the size of the TB is determined further based on the comparing of the set of intermediate informational bits to the threshold.

In one configuration, the apparatus 702, and in particular the cellular baseband processor 704, includes means for determining the scale factor based on the signaling received from the base station.

In one configuration, the scale factor is determined based on the slot aggregation factor, and the slot aggregation factor is associated with a number of repetitions configured for uplink transmissions on an uplink shared channel.

In one configuration, the means for determining the scale factor is configured to identify an entry in a table that indicates the scale factor using an index value, and the signaling from the base station comprises the index value.

In one configuration, the apparatus 702, and in particular the cellular baseband processor 704, includes means for receiving, from the base station, other signaling for configuration of a set of entries in the table, each entry of the set of entries comprising at least a respective index value corresponding with a respective scale factor greater than or equal to one (1).

In one configuration, the signaling for configuration of the at least one of the scale factor or the slot aggregation factor associated with the TB size comprises information indicating at least one of a modulation order or a coding rate, and the scale factor is determined based on the at least one of the modulation order or the coding rate.

In one configuration, the scale factor is greater than or equal to one (1).

In one configuration, the scale factor is associated with increasing an effective code rate from another effective code rate associated with another TB size.

In one configuration, the at least one of the scale factor or the slot aggregation factor is inapplicable to downlink signaling from the base station to the apparatus 702.

The aforementioned means may be one or more of the aforementioned components of the apparatus 702 configured to perform the functions recited by the aforementioned means. As described supra, the apparatus 702 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

FIG. 8 is a diagram 800 illustrating an example of a hardware implementation for an apparatus 802. The apparatus 802 may be a base station or similar device or system, or the apparatus 802 may be a component of a base station or similar device or system. The apparatus 802 may include a baseband unit 804. The baseband unit 804 may communicate through a cellular RF transceiver. For example, the baseband unit 804 may communicate through a cellular RF transceiver with a UE 104, such as for downlink and/or uplink communication, and/or with a base station 102/180, such as for IAB.

The baseband unit 804 may include a computer-readable medium/memory, which may be non-transitory. The baseband unit 804 is responsible for general processing, including the execution of software stored on the computer-readable medium/memory. The software, when executed by the baseband unit 804, causes the baseband unit 804 to perform the various functions described supra. The computer-readable medium/memory may also be used for storing data that is manipulated by the baseband unit 804 when executing software. The baseband unit 804 further includes a reception component 830, a communication manager 832, and a transmission component 834. The communication manager 832 includes the one or more illustrated components. The components within the communication manager 832 may be stored in the computer-readable medium/memory and/or configured as hardware within the baseband unit 804. The baseband unit 804 may be a component of the base station 310 and may include the memory 376 and/or at least one of the TX processor 316, the RX processor 370, and the controller/processor 375.

The reception component 830 may be configured to receive signaling on a wireless channel, such as signaling from a UE 104. The transmission component 834 may be configured to transmit signaling on a wireless channel, such as signaling to a UE 104. The communication manager 832 may coordinate or manage some or all wireless communications by the apparatus 802, including across the reception component 830 and the transmission component 834.

The reception component 830 may provide some or all data and/or control information included in received signaling to the communication manager 832, and the communication manager 832 may generate and provide some or all of the data and/or control information to be included in transmitted signaling to the transmission component 834. The communication manager 832 may include the various illustrated components, including one or more components configured to process received data and/or control information, and/or one or more components configured to generate data and/or control information for transmission. In some aspects, the generation of data and/or control information may include packetizing or otherwise reformatting data and/or control information received from a core network, such as the core network 190 or the EPC 160, for transmission.

The communication manager 832 includes a TB size determining component 840 and a signal generating component 842. The TB size determining component 840 may be configured to receive (through the reception component) a BSR from the UE 104, which may indicate data buffered at the UE 104 for uplink transmission, e.g., as described in connection with 602 of FIG. 6.

The TB size determining component 840 may determine whether the buffered data includes one or more payloads that are of a size that can be accommodated on a single TB of a currently configured size, or if the buffered data includes or more packets of a size greater than (or equal to) the size currently configured for TBs. If the latter, the TB size determining component 840 may determine that the UE 104 may benefit from an increased TB size, e.g., if the TB size determining component 840 detects that the UE 104 is near a cell edge or in limited coverage.

The TB size determining component 840 may determine to instruct the UE 104 to transmit a data payload in a TB with a modified size based on the received BSR, e.g., as described in connection with 604 of FIG. 6. The TB size determining component 840 may determine whether the buffered data indicated by the BSR includes one or more payloads that are of a size that can be accommodated on a single TB of a currently configured size, or if the buffered data includes or more packets of a size greater than (or equal to) the size currently configured for TBs. If the latter, the TB size determining component 840 may determine that the UE 104 may benefit from an increased TB size, e.g., if the TB size determining component 840 detects that the UE 104 is near a cell edge or in limited coverage. Accordingly, the TB size determining component 840 may determine to instruct the UE 104 to transmit the data payload in a TB with a modified size.

The signal generating component 842 may generate and transmit (through the transmission component 834), to the UE 104, signaling for configuration of at least one of a scale factor or a slot aggregation factor associated with TB size for uplink transmission by the UE 104, e.g., as described in connection with 606 of FIG. 6. For example, the signaling may include DCI, a CG, a MAC CE, and/or an RRC message from the apparatus 802. The DCI may include semi-static or dynamic instruction from the apparatus 802 to determine a modified TB size for an uplink transmission, and/or to shift the modulation order of the MCS. The information may indicate at least one of a modulation order or a coding rate, and the scale factor may be determined by the UE 104 based on the at least one of the modulation order or the coding rate.

In some aspects, the signaling from the signal generating component 842 includes an index value identifying an entry in a table that indicates the scale factor using the index value. For example, the signal generating component 842 may generate and transmit, to the UE 104, other signaling for configuration of a set of entries in the table, each entry of the set of entries including at least a respective index value corresponding with a respective scale factor greater than or equal to one (1).

The scale factor and/or slot aggregation factor may be associated with increasing an effective code rate from another effective code rate associated with another TB size. The scale factor and/or slot aggregation factor may be inapplicable to downlink signaling to the UE 104. For example, a different table may be configured to modify the sizes of TBs on the downlink, and the downlink scale factors may be configured to reduce the TB size, and the downlink scalar values may be less than or equal to one (1). Conversely, the scale factor and/or slot aggregation factor may be applicable to uplink transmission and may be greater than or equal to one (1).

The reception component 830 may receive, from the UE 104, a TB of a scaled up or increased size including a data payload, e.g., as described in connection with 608 of FIG. 6. The TB may be of a scaled up or increased size relative to other TBs. For example, the TB may include multiple slots in which a set of payload bits are mapped and encoded with a redundancy version that is consistent across the multiple slots.

The apparatus 802 may include additional components that perform some or all of the blocks, operations, signaling, etc. of the algorithm(s) in the aforementioned call flow diagram(s) and/or flowchart(s) of FIGS. 4 and/or 6. As such, some or all of the blocks, operations, signaling, etc. in the aforementioned call flow diagram(s) and/or flowchart(s) of FIGS. 4 and/or 6 may be performed by a component and the apparatus 802 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 802, and in particular the baseband unit 804, includes means for transmitting, to a UE signaling for configuration of at least one of a scale factor or a slot aggregation factor associated with a TB size to be used by the UE for transmission; and means for receiving, from the UE, information on at least one TB having a size that is based on at least one of the scale factor or the slot aggregation factor.

In one configuration, the size of the TB is further based on at least one of a number of layers configured for transmission of the information by the UE, a coding rate configured for the transmission, a modulation order configured for the transmission, or a number of REs allocated to the transmission.

In one configuration, the signaling for configuration of the at least one of the scale factor or the slot aggregation factor associated with the TB size includes at least one of a DCI message, a MAC CE, a CG, or a RRC message.

In one configuration, the slot aggregation factor is associated with a number of repetitions configured for uplink transmissions by the UE on an uplink shared channel.

In one configuration, the signaling for configuration of the at least one of the scale factor or the slot aggregation factor associated with the TB size includes an index value corresponding with an entry in a table that indicates the scale factor.

In one configuration, the apparatus 802, and in particular the baseband unit 804, includes means for transmitting, to the UE, other signaling for configuration of a set of entries of the table, each entry of the set of entries including at least a respective index value corresponding with a respective scale factor that is greater than or equal to one (1).

In one configuration, the signaling for configuration of the at least one of the scale factor or the slot aggregation factor associated with the TB size includes information indicating at least one of a modulation order or a coding rate, and the size of the TB is based on the at least one of the modulation order or the coding rate.

In one configuration, the scale factor is greater than or equal to one (1).

In one configuration, the scale factor is associated with increasing an effective code rate from another effective code rate associated with another TB size.

In one configuration, the at least one of the scale factor or the slot aggregation factor is inapplicable to downlink signaling from the apparatus 802 to the UE.

The aforementioned means may be one or more of the aforementioned components of the apparatus 802 configured to perform the functions recited by the aforementioned means. As described supra, the apparatus 802 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include some communication and/or memory operations/procedures through which some information or value(s) are acquired, such as “receiving” (e.g., receiving information), “accessing” (e.g., accessing data in a memory), “detecting,” and the like.

As another example, reference to an element in the singular is not intended to mean “one and only one” unless specifically so stated, but rather “one or more.” In particular, reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication at a user equipment (UE), comprising:
determining a size of a transport block (TB) for transmission to a base station based on signaling received from the base station for configuration of at least one of a scale factor or a slot aggregation factor associated with the size of the TB; and
transmitting, to the base station, information on the TB in at least one slot, the TB being of the determined size.

2. The method of claim 1, wherein the size of the TB is further based on a set of intermediate informational bits that is based on a product of the scale factor multiplied with a number of layers for transmitting the information, a coding rate for transmitting the information, a modulation order for transmitting the information, and a number of resource elements (REs) allocated to transmitting the information.

3. The method of claim 2, further comprising:
comparing the set of intermediate informational bits with at least one threshold, wherein
the size of the TB is determined further based on the comparing of the set of intermediate informational bits to the threshold.

4. The method of claim 1, further comprising:
determining the scale factor based on the signaling received from the base station.

5. The method of claim 4, wherein the scale factor is determined based on the slot aggregation factor, and the slot aggregation factor is associated with a number of repetitions configured for uplink transmissions on an uplink shared channel.

6. The method of claim 4, wherein the determining the scale factor comprises:
identifying an entry in a table that indicates the scale factor using an index value,
wherein the signaling from the base station comprises the index value.

7. The method of claim 6, further comprising:
receiving, from the base station, other signaling for configuration of a set of entries in the table, each entry of the set of entries comprising at least a respective index value corresponding with a respective scale factor greater than or equal to one (1).

8. The method of claim 4, wherein the signaling for configuration of the at least one of the scale factor or the slot aggregation factor associated with the size of the TB comprises information indicating at least one of a modulation order or a coding rate, and the scale factor is determined based on the at least one of the modulation order or the coding rate.

9. The method of claim 1, wherein the scale factor is greater than or equal to one (1).

10. The method of claim 9, wherein the scale factor is associated with increasing an effective code rate from another effective code rate associated with another size of the TB.

11. The method of claim 1, wherein the at least one of the scale factor or the slot aggregation factor is inapplicable to downlink signaling from the base station to the UE.

12. A method of wireless communication at a base station, comprising:
transmitting, to a user equipment (UE), signaling for configuration of at least one of a scale factor or a slot aggregation factor associated with a size of a transport block (TB) to be used by the UE for transmission; and
receiving, from the UE, information on at least one TB having a size that is based on at least one of the scale factor or the slot aggregation factor.

13. The method of claim 12, wherein the size of the TB is further based on at least one of a number of layers configured for transmission of the information by the UE, a coding rate configured for the transmission, a modulation order configured for the transmission, or a number of resource elements (REs) allocated to the transmission.

14. The method of claim 12, wherein the signaling for configuration of the at least one of the scale factor or the slot aggregation factor associated with the size of the TB comprises at least one of a downlink control information (DCI) message, a medium access control (MAC) control element (CE), a configured grant (CG), or a radio resource control (RRC) message.

15. The method of claim 12, wherein the slot aggregation factor is associated with a number of repetitions configured for uplink transmissions on an uplink shared channel by the UE.

16. The method of claim 12, wherein the signaling for configuration of the at least one of the scale factor or the slot aggregation factor associated with the size of the TB comprises an index value corresponding with an entry in a table that indicates the scale factor.

17. The method of claim 16, further comprising:
transmitting, to the UE, other signaling for configuration of a set of entries of the table, each entry of the set of entries comprising at least a respective index value corresponding with a respective scale factor that is greater than or equal to one (1).

18. The method of claim 12, wherein the signaling for configuration of the at least one of the scale factor or the slot aggregation factor associated with the size of the TB comprises information indicating at least one of a modulation order or a coding rate, and the size of the TB is based on the at least one of the modulation order or the coding rate.

19. The method of claim 12, wherein the scale factor is greater than or equal to one (1).

20. The method of claim 19, wherein the scale factor is associated with increasing an effective code rate from another effective code rate associated with another size of another TB.

21. The method of claim 12, wherein the at least one of the scale factor or the slot aggregation factor is inapplicable to downlink signaling from the base station to the UE.

22. An apparatus for wireless communication at a user equipment (UE), comprising:
a memory; and
at least one processor coupled to the memory and configured to:
determine a size of a transport block (TB) for transmission to a base station based on signaling received from the base station for configuration of at least one of a scale factor or a slot aggregation factor associated with size of the TB; and
transmit, to the base station, information on the TB in at least one slot, the TB being of the determined size.

23. The apparatus of claim 22, wherein the size of the TB is further based on a set of intermediate informational bits that is based on a product of the scale factor multiplied with a number of layers for transmitting the information, a coding rate for transmitting the information, a modulation order for transmitting the information, and a number of resource elements (REs) allocated to transmitting the information.

24. The apparatus of claim 23, wherein the at least one processor is further configured to:
compare the set of intermediate informational bits with at least one threshold, wherein
the size of the TB is determined further based on the comparison of the set of intermediate informational bits to the threshold.

25. The apparatus of claim 22, wherein the at least one processor is further configured to:
determine the scale factor based on the signaling received from the base station.

26. The apparatus of claim 25, wherein the scale factor is determined based on the slot aggregation factor, and the slot aggregation factor is associated with a number of repetitions configured for uplink transmissions on an uplink shared channel.

27. The apparatus of claim 25, wherein the determination of the scale factor comprises to identify an entry in a table that indicates the scale factor using an index value, wherein the signaling from the base station comprises the index value.

28. An apparatus for wireless communication at a base station, comprising:
a memory; and
at least one processor coupled to the memory and configured to:
transmit, to a user equipment (UE), signaling for configuration of at least one of a scale factor or a slot aggregation factor associated with a transport block (TB) size to be used by the UE for transmission; and
receive, from the UE, information on at least one TB having a size that is based on at least one of the scale factor or the slot aggregation factor.

29. The apparatus of claim 28, wherein the size of the TB is further based on at least one of a number of layers configured for transmission of the information by the UE, a coding rate configured for the transmission, a modulation order configured for the transmission, or a number of resource elements (REs) allocated to the transmission.

30. The apparatus of claim 28, wherein the signaling for configuration of the at least one of the scale factor or the slot aggregation factor associated with the size of the TB comprises at least one of a downlink control information (DCI) message, a medium access control (MAC) control element (CE), a configured grant (CG), or a radio resource control (RRC) message.
